(19) United States
(12) Patent Application Publication
(10) Pub. No.: US 2016/0275566 A1
(43) Pub. Date: Sep. 22, 2016

(54) ON-LINE DIRECT RESPONSE PLATFORM FOR IDENTIFYING USERS

(71) Applicant: GeoCommerce Inc., Irvine, CA (US)

(72) Inventors: Jeff Sparrow, Tustin, CA (US); Mark Sullivan, Clovis, CA (US)

(21) Appl. No.: 15/076,531

(22) Filed: Mar. 21, 2016

Related U.S. Application Data
(60) Provisional application No. 62/136,407, filed on Mar. 20, 2015.
(60) Provisional application No. 62/136,408, filed on Mar. 20, 2015.
(60) Provisional application No. 62/136,442, filed on Mar. 20, 2015.

(51) Int. Cl. G06Q 30/02

(52) U.S. Cl. CPC G06Q 30/0269; G06Q 30/0261; G06Q 30/0264; G06Q 30/0275

(57) ABSTRACT

Methods and systems disclosed provide for advertisement opportunities based on preselected user profiles and trigger events. The user profiles may comprise available impression times, index values and cost of acquisition. Advertisement content may be provided to devices associated with the preselected user profiles.

### PRIORITY

This application claims priority to U.S. Application No. 62/136,407, filed Mar. 20, 2015, and U.S. Application No. 62/136,408 filed Mar. 20, 2015, and U.S. Application No. 62/136,442, filed Mar. 20, 2015, all of which are incorporated by reference in its entirety herein.

### TECHNICAL FIELD

The present disclosure is generally directed towards methods and systems for data driven marketing, and specifically to online advertising.

### BACKGROUND

Recently, advertising space has been opened up such that second and third parties can dynamically bid and/or display an advertisement within a portal of a website. Advertising units are now sold such that an advertiser can display an advertisement through a portal on a website. The advertisement unit communicates with advertisement servers, which are, in turn, coupled through the internet to open advertising exchanges. The advertisement exchanges permit bidding on advertising space on all of the advertisement units coming into the exchange. The exchange therefore permits selective observation of data transfers with the website's activities. For example, when a website page loads and the opportunity for an advertising unit to display an advertisement is made, the data stream may include the IP address, the website header, and associated cookie information for the particular browser making the advertisement request. Possible requesters can indicate interest in the space and possibly request additional information from the device, browser, or website hosting or viewing the portal.

Users have been traditionally viewed in isolation such that their activities were only observed while engaging a specific company's domain. For example, when shopping, a user may be observed as logged as shopping for particular items on a vendor's website. Although this information is useful for the vendor when a user returns to a website, beyond that, the information in isolation is not given much value.

Additionally, users are typically identified in isolation from one device to another. That is, users are not related to multiple devices, locations etc. Thus, a user at a business address would not be identified as the same person at their home address. Cookies may be useful but are typically limited in that they only identify the individual using a particular device. Accordingly, identifying a user across multiple devices (smart phones, tablets, laptops, desktops, etc.) requires direct action by a user such as logging in or entering identifying information. Therefore, advertisers can be blind to advertising opportunities to individuals (or specific group of individuals) that are a desirable target audience if the user information not available with the advertising opportunity.

### BRIEF DESCRIPTION OF THE FIGURES

FIG. 1 illustrates an exemplary behavioral map that may be created for a user based on observing information exchanges of the user while online in addition to offline public information.

FIG. 2 illustrates an exemplary visual representation of a special database that relates persistent and semi-persistent data objects of a user to a specific point by observing networked activities.

FIG. 3 illustrates an exemplary flow diagram of exemplary methods described herein.

### DETAILED DESCRIPTION

The present embodiments allow advertisers to reach specific targeted individuals with advertisement opportunities that may translate into higher conversions, more sales and more positive returns on marketing investment. To that end, exemplary embodiments provide methods and systems for employing user profiles in conjunction with trigger events to provide valuable advertisement opportunities to advertisers.

As used herein “user profile” and “user profiles” broadly denote user information and activity. In an exemplary embodiment, every time a user is observed on line, persistent and semi-persistent identifiers may be observed. These identifiers may be used and related to each other, and ultimately relate each to a physical address associated with a user. The physical address may be one or more addresses of a user and include locations defined in reference to a grid, locating system, in relation to a reference, or otherwise identifiable or describable position. For example, a physical address may be the present location of the user in terms of GPS coordinates or latitude/longitude coordinates. Physical addresses may also include postal address of locations frequented by the user. Physical address may include work or residential addresses. Additionally, a user may be tracked to correlate physical addresses of a user along with the time and/or duration of those visits.

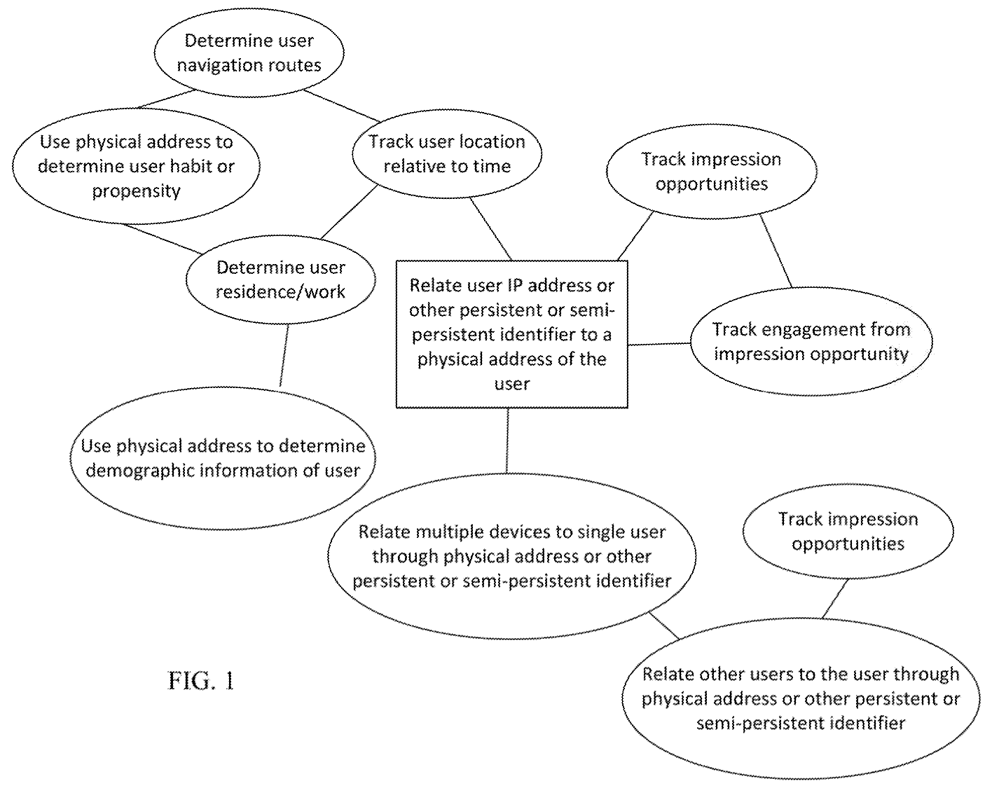

A behavioral map, such as the exemplary map shown in FIG. 1 may be created for a user profile based on observing information exchanges of the user during on-line transactions, and off-line public information. The behavioral map may also be used to determine a value for an advertising opportunity for a user profile.

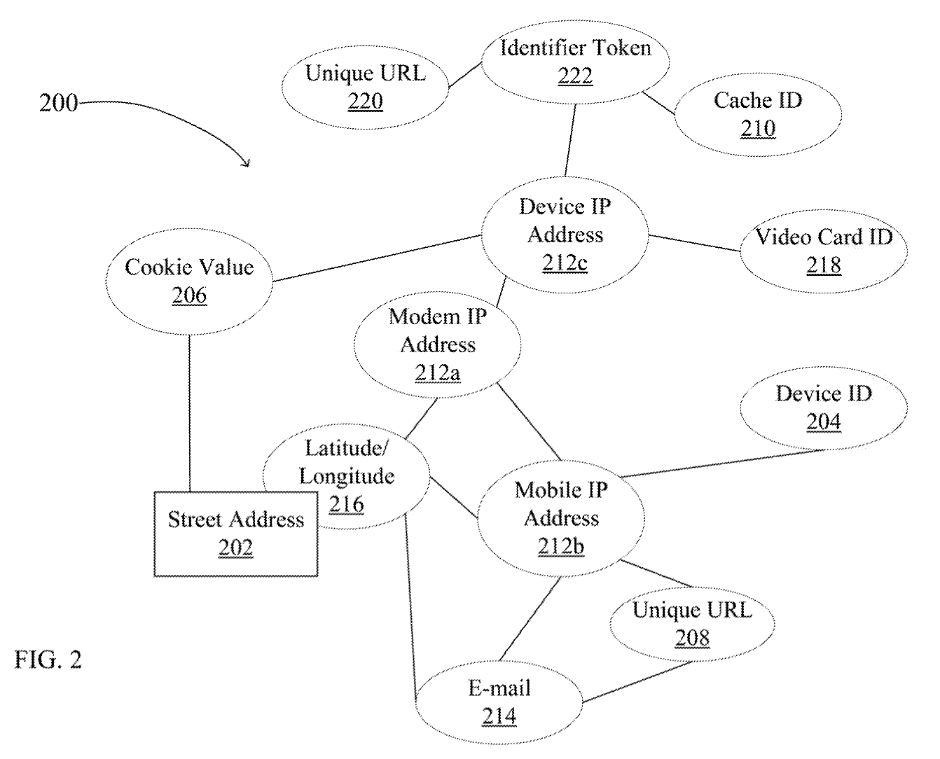

Additionally, as exemplified in FIG. 2, semi-persistent and persistent identifiers may be used to associate a user to a physical address. The unique URL 220, identifier token 222, and cache ID 210 may be associated together when the user engages a secure connection. The device IP address 212c is related to the street address 202 through the cookie value 206, when a user uses an auto-fill form of a website. Other unique set of persistent or semi-persistent identifiers may be tied to a specific device and used to create other data objects within the spatial database. For example, device ID 204 which uniquely identifies a device may be related to an IP address 212c and used to identify or relate other information pieces passed or logged with the device ID. A video card ID 218 may be related to a Device IP address 212c. Modem IP address 212a, mobile IP address 212b, and latitude/longitude of a mobile device may be related together when the mobile device connects to the modem. E-mail 214 and unique URL 208 may be related when a user launches a website from within an email.

In an exemplary embodiment, user location and activity may be tracked through one or more devices. For example, one or more devices including a location enabled mobile device (e.g. smartphone, tablet, etc.) can relate user activity such as websites and physical locations visited. Such data can be used to also determine a user's available impression time. This type of user location and behavior data can be stored in the user profile. Additionally, the information in the user profile may be expressed in a manner that indicates the value of the advertisement opportunity, such as a time interval where a particular user of interest is within an available impression time and can receive an advertisement. In an exemplary embodiment, the user profile may be used to calculate one or more index values for a user. Index values may be used for purposes of marketing advertisement opportunities.

Methods of obtaining and building user profile information, including IP address, physical location, behavior and available impression time, along with index values, are further described in International Application Nos. PCT/US2015/021885, published as WO 2015/143407, filed Mar. 20, 2015, and PCT/US2015/021898, published as WO 2015/143420, filed on Mar. 20, 2015, which are hereby incorporated by reference as if fully disclosed herein.

In an exemplary embodiment, the user profile may be stored on a server that is communicatively coupled with sources for collecting user data. A non-limiting example of a data source may be a cookie stored on a browser. Through this network of sources, a user profile is defined which can comprise one or more device IDs, one or more location data, and on or more other pieces of information (IP address, etc.). Thus, for example, user profiles associated with an address in a particular zip code may be identified as of interest to certain advertising companies.

In the exemplary embodiments, the user profiles may be preselected for advertisement based on a trigger event. Here, “preselected” generally denotes identifying certain user profiles as a candidate for receiving advertisement content. The user profile may be identified in a variety of ways including direct or indirect identification. For example, a user logging onto a website may result in direct identification of that user. On the other hand, identifying a user through a certain IP address or certain device IDs (e.g. MAC address) etc., that are associated with the user profile, may be examples of indirect identification. Of course, with indirect identification, a certain confidence factor may be needed. For instance, if a certain device ID has been detected in connection with a user ID, it may create a sufficient basis for indirect identification.

The value of an advertising opportunity may depend on the particular time a user is reached. For example, a user impression time may be determined and subsequently used to increase the return on investment for advertisers. In an exemplary embodiment, if users of particular interest to certain advertisement companies are identified during a time which falls within the user's available impression time, the user profile may be preselected to receive advertisement content. Therefore, in some instances, a user profile may be preselected based on available impression time. However, in some instances, a user profile may not include a particular available impression time. Accordingly, such users are essentially preselected anytime they are identified.

The value of an advertising opportunity may depend on device identity. Specifically, a user profile may be preselected based on association with a certain device ID (e.g. MAC ID). Accordingly, one or more devices may be on a watch list such that upon identification, the associated user profile is deemed a candidate for receiving advertisement content.

In the exemplary embodiments, advertisement content may be delivered upon occurrence of a trigger event. The trigger even can occur when a preselected user profile is identified at one or more addresses. In an exemplary embodiment, the addresses can include physical address, zip code, latitude and longitude coordinates, or any combination thereof. Thus, when a preselected user profile is identified at an address (e.g. within a list of addresses) then the user profile data is passed on to advertisement companies as an advertisement opportunity, or identified as a target for bidding.

As a non-limiting example, a user may be identified directly or indirectly at physical location through a smart device and served advertisement content on that device. Specifically, the individual (associated with a stored user profile) using a smartphone may be recognized by a smart device at a vendor's location. If the individual is then deemed a preselected user, his or her presence at the physical location may trigger an advertisement opportunity whereby advertisement content is sent to the individual's smartphone.

In an exemplary embodiment, upon a trigger event the user data may be passed on as an index value. This value may indicate an advertisement opportunity on a website. It may also comprise a price or cost of acquisition for the advertising opportunity. For example, if the available impression time for a user profile (or type of profile) is rare, the advertisement opportunity could correspondingly have a higher cost of acquisition. This way, advertisers can pay to reach the right audience rather than taking a shotgun approach and hoping their marketing investment was not wasted.

The advertisement opportunity may take many forms. In an exemplary embodiment, it comprises a banner ad space. Accordingly, an advertisement company that secures this opportunity may display their content as a banner ad. Other types of ads include, search engine ads (Google, Bing, etc.) pop-up/pop-under ads, floating ads, expanding ads, social media ads (Facebook, Twitter, etc.), mobile ads, video ads (YouTube, Vine, etc.), in-game ads and combinations thereof. Essentially any form of online advertisement compatible with the exemplary embodiments is contemplated here.

Advertisement companies may secure advertisement opportunity in a variety of ways. In an exemplary embodiment, the advertisement companies bid on the advertisement opportunity in an auction. Other methods may include preselection of an advertisement company (or companies) to receive the opportunity. The winning advertising company then selects or uses preselected advertisement content to be displayed to the user (e.g. to the user mobile or desktop device).

In an exemplary embodiment, the present system stores one or more user profiles along with trigger event information and instructions for providing the advertisement opportunity to advertisement companies based on the trigger event. Therefore by virtue of creating the advertisement opportunity and allowing the advertising companies to distribute their content, the present system causes an advertisement to be displayed to a user (e.g. user mobile device, desktop etc.).

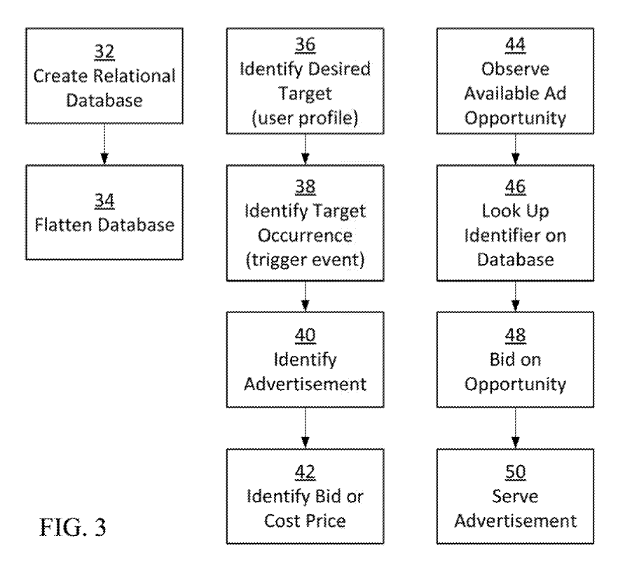

FIG. 3 illustrates an exemplary flow diagram of exemplary methods described herein.

The first column represents an exemplary platform that is used to identify a user through one or more persistent and semi-persistent identifiers, such as those of co-pending, co-owned applications incorporated above. First, at step 32 the relationships of persistent and semi-persistent identifiers are related including a confidence level based on the number of associations between any two or more of the identifiers. The relational database, at step 34, may be flattened into a traditional database for efficient look up. The flattened database may include the persistent and semi-persistent identifiers of interest. For example, the flattened database may include identifiers likely present in an advertising opportunity (such as device id, ip address, or one or more select cookie identifiers). Accordingly, the flattened database may include a subset of identifiers as those used in the relational database. The flattened database may also include identifiers that are likely of interest to identifying a target for an advertisement, such as one or more physical addresses. The relational database may be flattened on a periodic basis to update information or upon an occurrence, such as the update of one or more entries or upon a new association. The relational database may also be flattened on demand, such that when an advertising campaign is initiated, the available information about a target pool is retrieve.

The second column represents defining a target. For example, at step 36 an advertising agency may identify potential targets for a campaign. The identified target may be all people that live, work, commute, are physically present at or through a given geographic area, and combinations thereof. Exemplary embodiments for identifying a target may use for example a user interface such as that described by International Application No. PCT/US2015/021898, published as WO 2015/143420, filed Mar. 20, 2015, and incorporated by reference herein in its entirety. Identifying a target may include other relevant identifiers, such as medium incomes, political associations, purchasers of certain merchandise or brands, or any factor relevant to a marketer. The relevant identifiers may be present in the flattened database either directly from the created relational database or incorporated from other data sources, such as public data sources, purchased data source, demographic data sources, etc. For example, additional identifiers may be incorporated from private and public sources having one or more common identifiers to the relational database, such as a physical address to integrate the data sources together into a consolidated database.

A marketer may also, at step 38, identifier a target occurrence. This may be the triggering event that defines when and/or if the desired target is an actual target. For example, a triggering event may be set on a time of day. A triggering event may be based therefore on a likelihood that a person is in a geographic location at a given time, such as at lunch, weekend, business hours, etc. A triggering event based on time of day may be used to target likely candidates in a geographic location when they are identified to be present. For example, the flattened database may include one or more physical addresses associated with a user, such as residential address. The triggering event associated with a residential address may be after business hours or weekends when the target is likely to be at or near the associated address. A triggering event may also be based on time so that the business associated with the campaign is open and available for customers, or for incentives based on off peak times. A triggering event may also be actual presence at or near a location based, for example, on a real time or near real time (within a window of time) identifier of a GPS location or other location information is known. Other triggering events may include an identification of a target profile made available at an advertising opportunity.

The advertiser may also identify other attributes associated with the campaign, such as creating and/or supplying a specific advertisement associated with the target, at step 40, and/or setting a bid price (such as a bid range, max bid price, or campaign amount) for an individual or the group of an identified target, at step 42. This information may be used once a target is actually available as an opportunity to acquire the opportunity and supply the associated advertisement to the acquired opportunity.

The third column of FIG. 3 represents the actual opportunities, identifying the opportunities of interest, and acquiring those opportunities of interest in an efficient manner. At step 44, advertising opportunities are observed or made available. These may be opportunities through one or more bid platforms for banner ads or other advertising space presented through identified or unidentified websites. These may also, for example, include advertising space on one or more websites either as dedicated or banner spaces. The advertising opportunity may include one or more associated pieces of information for identifying a user. For example, an IP address, host website, cookie identifier, or other identifier may be provided when the advertising opportunity is made available. At step 46, the provided identifier is used as a look up key on a look up database. The look up database may include the flattened and/or consolidated database as supplemented or modified by the identity of targets and/or inclusion of additional information based on identifying, bidding on, or supplying an advertisement to a target. The look up database may permit efficient look up to quickly identify a desired target. It may also provide a bid price, or max bid for a given target and/or supply an associated advertisement or identify a desired advertisement for that target. At step 48, an informed bid may be made based on the desirability of the target. In an exemplary embodiment, specific bid price may be associated with the desirability of a target based on one or more identifiers associated with the target. In this respect, a marketer can pay not just for obtaining a set of eyes on their advertisement, but may pay a specific amount for receiving a specific class of eyes on their advertisement.

Exemplary embodiments may therefore be used as a method of data driven marketing. The data driven marketing may include providing a first user profile. The first user profile may be any profile comprising one or more persistent or semi-persistent identifiers for identifying a user on line. In an exemplary embodiment, the user profile comprises a first device ID (or other persistent or semi-persistent identifier) associated with a first location. The first location may be a physical address associated with a user, such as a residential address, a work address, a frequented address, address along a commuter route, and/or present physical location. The data driven marketing method may also include identifying a trigger event and/or determining the occurrence of at least one trigger event. A trigger event may include the occurrence of any event and/or presence of a specific set of attributes. For example, the trigger event may include identifying the presence of at least one preselected user profile at a second location.

In an exemplary embodiment, identifying the presence of at least one preselected user profile at a second location may occur when a specific target of an advertising campaign is identified at a specific location. Upon occurrence of a trigger event, advertisement content may be provided from an advertiser to a device associated with the preselected user profile. A device associated with the preselected user profile may be a device in which the user has engaged to perform a specific task. Exemplary embodiments include the mobile devices of the user, such as laptop, tablet, and/or phone. Other devices associated with the preselected user profile may be any device in proximity or within a given geographic distance to the user. For example, smart billboards or other electronic interfaces that may present information to a by passer or user that is in proximity to the user.

In an exemplary embodiment, a user may be identified as proximate an advertising opportunity. For example, a digital advertising location, such as a digital bill board, or digital device having a programmable screen is provided in a location. Exemplary digital advertising locations may include, for example, help screens that permit a user to enter and retrieve information, such as found at airports and/or hotels. Other digital advertising locations may be digital bill boards, pay phones with digital screens, information kiosks, displays or monitors, such as used for menus or flight arrival/departure times, etc. The digital advertising location may be associated with a geographic location, such as its physical location. The digital advertising location may be configured to communicate or receive information from a digital device of a user, such as a passerby. For example, the digital advertising location may include a wifi signal, Bluetooth, or other communication signal for receiving, communicating with, or identifying the presence of a digital device. The digital advertising location may be configured to present advertising opportunities similar to the banner ads or other advertisements described herein. The digital advertising location may be configured to permit an opportunity to advertise or present an advertisement to a user based on an identification of a user in proximity to the digital advertising location, such as based on an identifier of the user mobile device. For example, correlation to the method described in FIG. 3, may be that the digital advertising location provides an observable ad opportunity and supplies a device id or other identifier of a detected user in proximity to the digital advertising location. An advertiser may thereafter bid on the advertising opportunity and present an advertisement to the user at or through the digital advertising location as if the digital advertising location were a device of the user, based on the proximity of the user to the location.

In an exemplary embodiment, identifying the presence of at least one preselected user profile at a second location may occur when a specific target of an advertising campaign is identified at a specific location. In an exemplary embodiment, a target for an advertising campaign may be presented with tailored or specific advertising based on their immediate or semi-immediate proximity to a geographic location and/or based on a historical proximity to a geographic location. For example, when a user profile is detected at a specific location, an advertisement may be served to the user. The advertisement may be through an advertising opportunity, such as through a banner ad made available through a website or game application run by the user on a user device, or may be a specifically served advertisement, such as through pop up, text message, or other specifically delivered message to the user, or may be on a remote device in proximity to the user, such as a digital information kiosk, check out screen, or other digital display. As another example, a target for an advertising campaign may be presented based on a history associated with a specific geographic location and/or based on an associated time related to the specific geographic location of a target. In a specific case, an advertisement may be presented for a lunch deal on a restaurant in proximity to a target's place of work made available to a target when an advertising opportunity is made available to that target in the hours preceding lunchtime.

While the foregoing written description of the embodiments enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention. For example, the features and components of the instant description may be used in any combination. Features may be performed on different components, such as the target's device, remote servers, or other computer configuration. Exemplary methods are also provided herein. The associated steps may be performed in different order, steps may be duplicated, added, removed, combined, subdivided or otherwise rearranged and remain within the scope of the instant disclosure.

What is claimed is:

1. A method of data driven marketing comprising:
providing a first user profile,
wherein the user profile comprises a first device ID associated with a first location;
determining the occurrence of at least one trigger event,
wherein the trigger event comprises identification of at least one preselected user profile at a second location; and
upon occurrence of a trigger event, causing advertisement content to be provided from an advertiser to a device associated with the preselected user profile.

2. The method of claim 1, wherein the device ID comprises a MAC address.

3. The method of claim 1, wherein the first location comprises a physical address.

4. The method of claim 1, wherein at least one user profile is preselected based on association with a device ID.

5. The method of claim 1, wherein at least one user profile comprises an available impression time.

6. The method of claim 1, wherein at least one user profile is preselected based on location.

7. The method of claim 1, wherein the trigger event occurs when the first user profile is identified at a second location.

8. The method of claim 1, wherein the second address comprises a physical address.

9. The method of claim 1, wherein the second address comprises an IP address.

10. The method of claim 1, further comprising offering an advertisement opportunity to at least one advertisement company upon occurrence of the trigger event.

11. The method of claim 10, wherein the advertisement opportunity comprises a banner ad space.

12. The method of claim 10, comprising offering the advertisement opportunity to a plurality of advertisement companies at an auction.

13. The method of claim 1, wherein at least one user profile comprises available impression time.

14. The method of claim 1, wherein at least one user profile comprises a value index.

15. The method of claim 1, wherein the user profile comprises cost of acquisition.

16. The method of claim 1, further comprising preselecting an advertising company to display advertisement content based on a trigger event.

17. The method of claim 1, further comprising preselecting an advertising company to display advertisement content based on the company's acceptance of the cost of acquisition.

18. The method of claim 13, further comprising preselecting at least one advertising company based on the available impression time.

19. A method of data driven marketing comprising:
identifying a first user profile on a first website,
wherein the user profile comprises a first device ID associated with a first location;
determining the occurrence of at least one trigger event,
wherein the trigger event comprises identification of at least one preselected user profile at a second location; and
upon occurrence of the trigger event, providing advertisement opportunity on the first website to at least one advertisement company.

20. A method of data driven marketing comprising:
identifying a first user profile at a first physical location,
wherein the user profile comprises a first device ID associated with a first location;
determining the occurrence of a trigger event,
wherein the trigger event comprises identification of a first device associated with the first user profile, at a second location; and
upon occurrence of a trigger event, providing advertisement opportunity on the first device to at least one advertisement company.
